(19) United States
(12) Patent Application Publication
(10) Pub. No.: US 2026/0276044 A1
(43) Pub. Date: Sep. 17, 2026

(54) CONTROL APPARATUS FOR VEHICLE

(71) Applicant: TOYOTA JIDOSHA KABUSHIKI KAISHA, Toyota-shi (JP)

(72) Inventors: Shota MIYAKE, Toyota-shi (JP); Masamitsu KOYASU, Nagoya-shi (JP); Naoki HIURA, Toyota-shi (JP); Tooru MATSUBARA, Toyota-shi (JP)

(73) Assignee: TOYOTA JIDOSHA KABUSHIKI KAISHA, Toyota-shi (JP)

(21) Appl. No.: 19/563,243

(22) Filed: Mar. 11, 2026

(30) Foreign Application Priority Data
Mar. 11, 2025 (JP) 2025-038776

(51) Int. Cl. F16D 48/06; F16D 13/74

(52) U.S. Cl. CPC F16D 48/066; F16D 13/74; F16D 2500/30412; F16D 2500/30415; F16D 2500/30426; F16D 2500/30825; F16D 2500/3111; F16D 2500/3127; F16D 2500/70426

(57) ABSTRACT

A vehicle control apparatus including (a) a clutch controller configured to place a wet multi-plate friction clutch into a slip state, when a vehicle starts running or runs at a small running speed, (b) a state determiner configured to determine whether a running road is a flat road or an uphill road, depending on whether or not a road gradient is smaller than a predetermined gradient value, and (c) a pump controller configured to control a pump rotational speed of an electric fluid pump for supplying a fluid for lubricating the friction clutch. When the running road is determined to be the flat road, the pump controller sets the pump rotational speed to a flat-road rotational speed. When the running road is determined to be the uphill road, the pump controller sets the pump rotational speed to an uphill-road rotational speed that is larger than the flat-road rotational speed.

This application claims priority from Japanese Patent Application No. 2025-038776 filed on Mar. 11, 2025, the disclosure of which is herein incorporated by reference in its entirety.

### FIELD OF THE INVENTION

The present invention relates to a control apparatus for a vehicle that includes a wet multi-plate friction clutch in a power transmission path between a power source and a drive wheel.

### BACKGROUND OF THE INVENTION

There is known a control apparatus for a vehicle that includes a drive wheel, a power source and a friction clutch provided in a power transmission path between the power source and the drive wheel. For example, the vehicle control apparatus described in Patent Document 1 is such a control apparatus. Patent Document 1 discloses that, when the vehicle is to start running on a slope, a rotational speed of the power source is increased with the friction clutch being in a released state, and then the friction clutch is controlled toward an engaged state, and the torque of the power source is transmitted to the drive wheel via the friction clutch in a slip state, thereby improving a hill-climbing performance.

### PRIOR ART DOCUMENT

### Patent Document

[patent Document 1] JP 2022-154284 A

### SUMMARY OF THE INVENTION

When the vehicle runs on an uphill road at a small running speed, an input torque to the friction clutch is made large and a difference between input and output rotational speeds of the friction clutch is made large, so that an amount of heat generated in the friction clutch placed in the slip state is likely to be increased thereby resulting in reductions of starting and running performances in order to protect the friction clutch. If the friction clutch is a wet multi-plate friction clutch, it might be possible to cool the friction clutch by supplying an oil to lubricate the friction clutch by an electric oil pump. If a rotational speed of the electric oil pump for driving the electric oil pump is always set to a large rotational speed, temperature of components of the electric oil pump will be increased whereby durability of the electric oil pump could be reduced. Further, if the temperature of the components of the electric oil pump is increased, a protective control could be executed for temporarily stopping operation of the electric oil pump in order to protect components of the electric oil pump.

The present invention was made against the background of the above circumstances, and its purpose is to provide a control apparatus for a vehicle, which is capable of suppressing an amount of heat generation in a wet multi-plate friction clutch when the vehicle starts running or runs on an uphill road.

According to the present invention, there is provided a control apparatus for a vehicle which is to run on a running road and which includes (i) a drive wheel, (ii) a power source, (iii) a wet multi-plate friction clutch provided in a power transmission path between the power source and the drive wheel and (iv) an electric fluid pump that is to be driven at a pump rotational speed so as to supply a fluid for lubricating the friction clutch. The control apparatus includes: (a) a clutch controller configured to place the friction clutch into a slip state, when the vehicle is caused to start running or is caused to run at a running speed within a predetermined small speed range; (b) a state determiner configured to determine that the running road is an uphill road when a road gradient is not smaller than a predetermined gradient value, and to determine that the running road is a flat road when the road gradient is smaller than the predetermined gradient value; and (c) a pump controller configured, when it is determined that the running road is the flat road, to set the pump rotational speed to a predetermined flat-road rotational speed, and configured, when it is determined that the running road is the uphill road, to set the pump rotational speed to a predetermined uphill-road rotational speed that is larger than the flat-road rotational speed.

In the control apparatus according to the present invention, when the running road is determined to be a flat road, the pump rotational speed (at which the electric fluid pump is to be driven) is set to the predetermined flat-road rotational speed. On the other hand, when the running road is determined to be an uphill road, the pump rotational speed is set to the predetermined uphill-road rotational speed that is larger than the flat-road rotational speed. As a result, when the running road is the uphill road, the flow rate of lubricating oil supplied to the friction clutch is increased as compared to when the running road is the flat road, thereby making it easier to cool the friction clutch. Because a large pump rotational speed is only set on the uphill road, activation of an electric-fluid-pump protection control is suppressed, so that the electric fluid pump is unlikely to be easily stopped. As a result, an amount of heat generated in the wet multi-plate friction clutch can be suppressed when the vehicle is caused to start running or caused to run on an uphill road.

### BRIEF DESCRIPTION OF THE DRAWINGS

FIG. 1 is a view schematically showing a construction of a vehicle to which the present invention is applied, and also control functions and main parts of a control system for various controls in the vehicle.

FIGS. 2A and 2B are views explaining an example of a construction of a starting clutch, wherein FIG. 2A shows the construction of the starting clutch with an internal tooth disc, and FIG. 2B shows the starting clutch with an external tooth disc.

FIG. 3 is a flowchart showing a main control operation of an electronic control apparatus, namely, a control routine executed by the electronic control apparatus for suppressing an amount of heat generation in the starting clutch when the vehicle starts running or runs on an uphill road.

FIG. 4 is a time chart when the control routine shown in the flowchart of FIG. 3 is executed in a case in which the vehicle enters an uphill road during running of the vehicle.

FIG. 5 is a time chart when the control routine shown in the flowchart of FIG. 3 is executed in a case in which a running speed is increased after the vehicle enters an uphill road during running of the vehicle.

FIG. 6 is a time chart when the control routine shown in the flowchart of FIG. 3 is executed in a case in which the vehicle starts running on an uphill road.

### DETAILED DESCRIPTION OF PREFERRED EMBODIMENT

Hereinafter, a preferred embodiment of the present invention will be described in detail with reference to the drawings.

### Embodiment

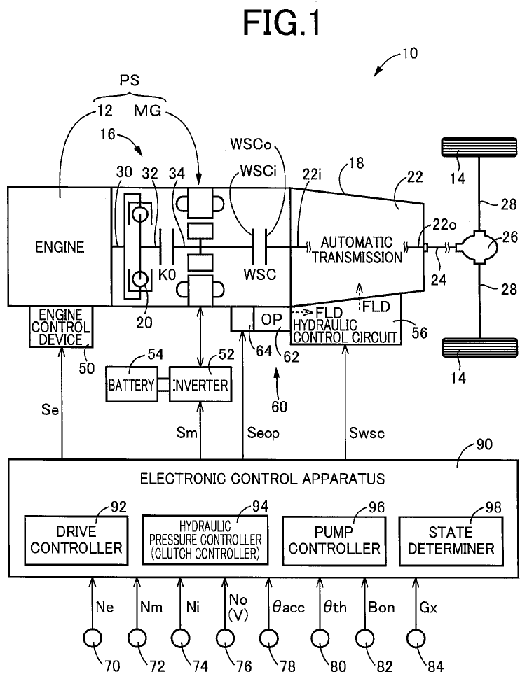

FIG. 1 is a view schematically showing a construction of a vehicle 10 to which the present invention is applied, and also control functions and main parts of a control system for various controls in the vehicle 10. As shown in FIG. 1, the vehicle 10 is a hybrid electric vehicle equipped with an engine 12 and an electric motor MG. The engine 12 and the electric motor MG each constitute a power source PS in the present invention. The vehicle 10 also includes drive wheels 14 and a power transmission device 16 that is provided in a power transmission path between the engine 12 and the drive wheels 14.

The engine 12 is, for example, a known internal combustion engine. An engine torque Te of the engine 12 is controlled by an engine control device 50 provided in the vehicle 10, which is controlled by an electronic control apparatus 90.

The electric motor MG is a known rotating electric machine, a so-called motor generator. The electric motor MG is connected to a battery 54 provided in the vehicle 10 via an inverter 52 provided in the vehicle 10. The inverter 52 is controlled by the electronic control apparatus 90, thereby controlling an electric motor torque Tm of the electric motor MG.

The power transmission device 16 is provided with a damper 20, a connection/disconnection clutch K0, a starting clutch WSC, an automatic transmission 22 and the like, within a casing 18, which is a non-rotary member attached to a body of the vehicle 10. The damper 20 is provided in a power transmission path between the engine 12 and the connection/disconnection clutch K0. The connection/disconnection clutch K0 is provided in a power transmission path between the engine 12 and the electric motor MG. The connection/disconnection clutch K0 is, for example, a hydraulic friction engagement device, and a controlled state of the connection/disconnection clutch K0 is to be switched among an engaged state, a slip state and a released state, for example. The starting clutch WSC is provided between the electric motor MG and the automatic transmission 22 in a power transmission path between the engine 12 and the drive wheels 14. The automatic transmission 22 is provided between the starting clutch WSC and the drive wheels 14 in a power transmission path between the power source PS and the drive wheels 14. The automatic transmission 22 is, for example, a known planetary gear type automatic transmission.

The power transmission device 16 includes a propeller shaft 24 connected to a transmission output shaft 22o, a differential gear device 26 connected to the propeller shaft 24 and a pair of drive shafts 28 connected to the differential gear device 26. The transmission output shaft 22o is the output rotary member of the automatic transmission 22. The power transmission device 16 includes, within the casing 18, an engine connection shaft 30 connecting the engine 12 and the damper 20, a damper connection shaft 32 connecting the damper 20 and the connection/disconnection clutch K0, and an electric-motor connection shaft 34 connecting the connection/disconnection clutch K0 and the starting clutch WSC. The electric motor MG is connected to the electric-motor connection shaft 34 in a power transmittable manner within the casing 18. The power transmission device 16 is located in the power transmission path between the power source PS and the drive wheels 14, excluding the damper 20 and the connection/disconnection clutch K0.

The starting clutch WSC includes an input plate WSCi connected to the electric-motor connection shaft 34 and an output plate WSCo connected to a transmission input shaft 22i. The starting clutch WSC is, for example, a known hydraulic friction engagement device. The starting clutch WSC is a wet multi-plate friction clutch in the present invention, and is provided in the power transmission path between the power source PS and the drive wheels 14. The transmission input shaft 22i is an input rotary member of the automatic transmission 22. The input plate WSCi is an input member of the starting clutch WSC. The output plate WSCo is an output member of the starting clutch WSC. A controlled state of the starting clutch WSC is to be switched among an engaged state, a slip state and a released state, with a starting clutch torque Twsc being changed by a starting-clutch hydraulic pressure PRwsc. The starting-clutch hydraulic pressure PRwsc is controlled by a hydraulic control circuit 56 provided in the vehicle 10. The starting clutch torque Twsc is a torque capacity of the starting clutch WSC.

The power of the power source PS is transmitted to the drive wheels 14 via the starting clutch WSC, for example. The power of the engine 12 is transmitted to the drive wheels 14 when the connection/disconnection clutch K0 and the starting clutch WSC are both in the engaged states or slip states. The power of the electric motor MG is transmitted to the drive wheels 14 when the starting clutch WSC is in the engaged state or slip state, regardless of the controlled state of the connection/disconnection clutch K0.

The vehicle 10 is equipped with an oil pump 60. The oil pump 60 includes a pump body 62 and a pump motor 64. The oil pump 60 is an electric oil pump that discharges an oil FLD used in the power transmission device 16 when the pump motor 64 rotates and drives the pump body 62. The oil FLD discharged by the oil pump 60 is supplied to the hydraulic control circuit 56. The hydraulic control circuit 56 supplies the starting-clutch hydraulic pressure PRwsc which is adjusted based on the oil FLD discharged by the oil pump 60. The oil FLD is a working fluid for operating the connection/disconnection clutch K0, the starting clutch WSC and the automatic transmission 22. The oil FLD is also used for lubricating and cooling various parts of the power transmission device 16. For example, the oil FLD is a fluid for lubricating the starting clutch WSC in the present invention. The oil pump 60 is an electric fluid pump in the present invention.

The vehicle 10 further includes the electronic control apparatus 90 as a controller. The electronic control apparatus 90 includes a so-called microcomputer equipped with, for example, a CPU, a RAM, a ROM and an input/output interface. The CPU executes various controls in the vehicle 10 by, for example, utilizing a temporary storage function of the RAM and performing signal processing in accordance with programs pre-stored in the ROM. The electronic control apparatus 90 is the control apparatus of the present invention.

The electronic control apparatus 90 receives various signals based on detection signals from various sensors provided in the vehicle 10. The various sensors include, for example, an engine rotational-speed sensor 70, an electric motor rotational-speed sensor 72, an input rotational-speed sensor 74, an output rotational-speed sensor 76, an acceleration opening-degree sensor 78, a throttle-valve opening-degree sensor 80, a brake switch 82 and an acceleration sensor 84. The various signals include, for example, an engine rotational speed Ne, an electric-motor rotational speed Nm, a transmission-input rotational speed Ni, a transmission-output rotational speed No, an acceleration opening degree θacc, a throttle valve opening degree θth, a brake-ON signal Bon and a longitudinal acceleration Gx.

The engine rotational speed Ne is a rotational speed of the engine 12. The electric-motor rotational speed Nm is a rotational speed of the electric motor MG. The electric-motor rotational speed Nm is also a rotational speed of the input plate WSCi, i.e., an input rotational speed of the starting clutch WSC. When the connection/disconnection clutch K0 is in the engaged state, the electric motor rotational speed Nm and the engine rotational speed Ne are considered to be the same. The transmission-input rotational speed Ni is a rotational speed of the transmission input shaft 22i. The transmission-input rotational speed Ni is also a rotational speed of the output plate WSCo, i.e., an output rotational speed of the starting clutch WSC. The transmission-output rotational speed No is a rotational speed of the transmission output shaft 22o. The transmission-output rotational speed No is also a rotational speed corresponding to a running speed V of the vehicle 10. The acceleration opening degree θacc is a signal that indicates an amount of accelerator operation by a driver of the vehicle 10, which indicates a magnitude of acceleration/deceleration operation made by the driver. The throttle-valve opening degree θth is a signal that indicates an opening degree of the electronic throttle valve. The brake ON signal Bon is a signal that indicates a state in which a brake pedal to activate a wheel brake is being operated by the driver. The longitudinal acceleration Gx is an acceleration of vehicle 10 in forward/reverse direction.

The electronic control apparatus 90 calculates a clutch rotational-speed difference ΔNwsc(=Nm−Ni) by using the electric-motor rotational speed Nm and the transmission-input rotational speed Ni. The clutch rotational-speed difference ΔNwsc is a difference between the input and output rotational speeds of the starting clutch WSC. The difference between the input and output rotational speeds of the starting clutch WSC is a difference between the input rotational speed of the starting clutch WSC and the output rotational speed of the starting clutch WSC.

The electronic control apparatus 90 outputs various command signals to various devices provided in the vehicle 10. The various devices include the engine control device 50, the inverter 52, the hydraulic control circuit 56 and the oil pump 60. The various command signals include an engine control command signal Se, an electric-motor control command signal Sm, a starting-clutch hydraulic control command signal Swsc and an oil-pump control command signal Seop.

The electronic control apparatus 90 includes a drive controller 92, a hydraulic controller 94 and a pump controller 96, so as to realize various controls in the vehicle 10.

The drive controller 92 calculates a drive demand amount DEM from the driver for the vehicle 10, for example, by applying the acceleration opening degree θacc and the running speed V to a drive demand amount map. The drive demand amount map is a stored relationship for calculating the drive demand amount DEM, and is determined in advance, for example, experimentally or by design. The drive demand amount DEM is, for example, a required drive torque Trdem [Nm] that is a required value of the drive torque Tr at the drive wheels 14, or a required drive power Frdem [N] that is a required value of the drive power Fr at the drive wheels 14. The drive controller 92 outputs the control command signals (Se, Sm) that control the power source PS such that a power source torque Tps is obtained to achieve the drive demand amount DEM. The power source torque Tps is a torque of the power source PS.

The hydraulic controller 94 determines whether a gear shift is required in the automatic transmission 22, for example, by using a predetermined gear shift map, and outputs a gear-shift control command signal to the hydraulic control circuit 56 to execute a gear shift control for the automatic transmission 22 such that the determined gear is formed as necessary. In controlling the gear shift of the automatic transmission 22, the hydraulic controller 94 switches each engagement device involved in forming the gear between a released state and an engaged state, for example.

When the vehicle 10 is being stopped due to braking, the hydraulic controller 94 outputs the starting-clutch hydraulic control command signal Swsc by which the starting clutch WSC is kept in the released state, for example. When the vehicle 10 starts running, the hydraulic controller 94 outputs a starting-clutch hydraulic control command signal Swsc that switches the starting clutch WSC from a released state to an engaged state while slipping. When the vehicle 10 starts running, the drive controller 92 outputs the control command signals (Se, Sm) by which the power source torque Tps is increased. When the vehicle 10 is running, the hydraulic controller 94 outputs the starting-clutch hydraulic control command signal Swsc by which the starting clutch WSC is kept in the engaged state. However, when the vehicle 10 is running at a running speed within a predetermined small speed range, for example, the hydraulic controller 94 outputs the starting-clutch hydraulic control command signal Swsc by which the starting clutch WSC is placed in the slip state. The predetermined small speed range is a small running range in which it is not desirable to place the starting clutch WSC into the engaged state, for example, to prevent engine stalling or to suppress vibrations. The hydraulic controller 94 is a clutch controller in the present invention, which controls the starting clutch WSC to the slip state when the vehicle 10 is caused to start running or when the vehicle 10 is caused to run at the running speed within the predetermined small speed range. It is noted that, when the vehicle 10 is stopped due to braking, the hydraulic controller 94 may, for example, control the starting clutch WSC to the slip state to an extent that starting clutch torque Twsc is hardly generated.

The pump controller 96 sets a normal-state rotational speed Neopnml according to the controlled states of the connection/disconnection clutch K0, the starting clutch WSC and the engagement devices in the automatic transmission 22. The pump controller 96 outputs the oil pump control command signal Seop by which the oil pump 60 is driven at the normal-state rotational speed Neopnml. The normal-state rotational speed Neopnml is, for example, a predetermined pump command rotational speed Neopis for supplying the oil FLD at a flow rate required for the operations of the connection/disconnection clutch K0, the starting clutch WSC and the engagement devices in the automatic transmission 22. The normal-state rotational speed Neopnml is also, for example, the predetermined pump command rotational speed Neopis for ensuring the flow rate of the oil FLD required for lubricating and cooling parts of the power transmission device 16. The pump command rotational speed Neopis is a command rotational speed of the oil pump 60, and corresponds to the pump rotational speed Neop when the oil pump 60 is driven. The pump rotational speed Neop is a rotational speed of the oil pump 60.

If the oil pump 60 is operated at a large rotational speed for a long period of time, for example, a coil temperature of the oil pump 60 is increased, so that a protective control is likely to be executed to temporarily stop the operation of the oil pump 60 to protect the parts. The normal-state rotational speed Neopnml is also, for example, the predetermined pump command rotational speed Neopis that enables the oil pump 60 to be operated continuously for a long period of time.

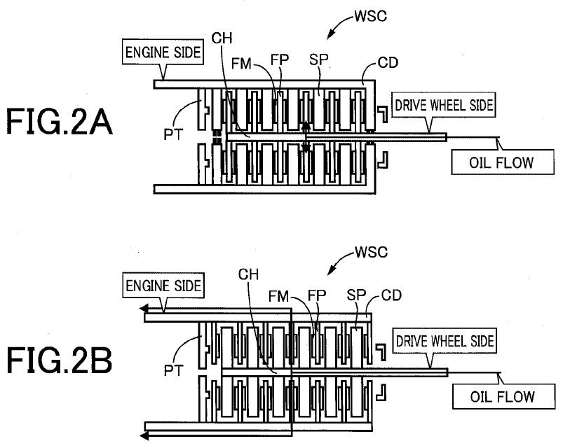

FIGS. 2A and 2B are views explaining an example of a construction of the starting clutch WSC. FIG. 2A shows the construction of the starting clutch WSC with an internal tooth disc, namely, with friction plates FP being located on an inner peripheral side. FIG. 2B shows the construction of the starting clutch WSC with an external tooth disc, namely, with the friction plates FP being located on an outer peripheral side.

As shown in FIGS. 2A and 2B, the starting clutch WSC includes a clutch drum CD, a clutch hub CH, separate plates SP, friction plates FP and a piston PT. The clutch drum CD is connected to the electric-motor connection shaft 34. The clutch hub CH is connected to the transmission input shaft 22i. The separate plates SP and the friction plates FP are interposed between each other, and constitute a plurality of generally annular-shaped plate members. When the starting-clutch hydraulic pressure PRwsc is supplied to the starting clutch WSC, the piston PT is pressed against the separate plates SP and friction plates FP, whereby the starting clutch WSC is controlled toward the engaged state.

In FIG. 2A, the separate plates SP serve as the input plate WSCi, and their outer peripheral edges are splined to an inner circumferential surface of the clutch drum CD so as to be non-rotatable relative to the clutch drum CD. The friction plates FP serve as the output plate WSCo, and their inner peripheral edges are splined to an outer circumferential surface of the clutch hub CH so as to be non-rotatable relative to the clutch hub CH. In FIG. 2B, the friction plates FP serve as the input plate WSCi, and their outer peripheral edges are splined to the inner circumferential surface of the clutch drum CD so as to be non-rotatable relative to the clutch drum CD. The separate plates SP serve as the output plate WSCo, and their inner peripheral edges are splined to the outer circumferential surface of the clutch hub CH so as to be non-rotatable relative to the clutch hub CH.

In the starting clutch WSC, the oil FLD is supplied to the separate plates SP and the friction plates FP for lubrication. The lubricating oil FLD is circulated through the clutch hub CH and is supplied from the axis toward the outer periphery by centrifugal force. The starting clutch WSC generates heat due to its slip state. If the starting clutch WSC generates the heat too much, the durability could be reduced, so that it is cooled by the lubricating oil FLD. The lubricating oil FLD is used to cool the starting clutch WSC.

During running of the vehicle 10 within a small running speed range, the rotational speed of the clutch hub CH is made small, so that the flow rate of the lubricating oil FLD supplied to the separate plates SP and the friction plates FP is made small and there is a risk of reduction of cooling performance. If a clutch input torque Tinwsc is large, the amount of heat generated in the starting clutch WSC is increased. Therefore, when the vehicle 10 is driven with a large load at a small running speed, for example, on an uphill road, the amount of heat generated in the starting clutch WSC is increased, so that placing the starting clutch WSC into the slip state is limited to protect the starting clutch WSC, thereby resulting in reduction of the starting and running performances. The clutch input torque Tinwsc is a torque inputted to the starting clutch WSC, i.e., an input torque to the starting clutch WSC.

Further, in the case (see FIG. 2B) in which the separate plates SP serve as the output plate WSCo in the starting clutch WSC, rotations of the separate plates SP having large heat capacity are stopped during stop of the vehicle 10, whereby the cooling performance is further reduced. Therefore, in the case in which the starting clutch WSC is constructed as shown in FIG. 2B, the cooling performance is inferior to the case in which the starting clutch WSC is constructed as shown in FIG. 2A, and there is a concern that the running performance may be further reduced. The heat capacity of the separate plates SP is a measure of how much heat is absorbed from friction members FM of the friction plates FP. When rotations of the separate plates SP are stopped, only portion of the separate plates SP are immersed in an oil pool, which means that an entirety of each of the separate plates SP is not immersed in the oil pool, so that the cooling performance is reduced. On the other hand, if surfaces of the friction members FM are smooth, the occurrence of abnormal vibrations known as judder is suppressed. The judder is an abnormal vibration that occurs when the power is transmitted with the starting clutch WSC being in the slip state. In the case (see FIG. 2B) in which the friction plates FP serve as the input plate WSCi in the starting clutch WSC, the oil FLD on the surface of the friction members FM can be blown away by rotation. For this reason, the starting clutch WSC having the construction as shown in FIG. 2B is inferior in the cooling performance as compared to the starting clutch WSC having the construction as shown in FIG. 2A, but is advantageous in the suppression of the judder.

In a case (not shown) in which the clutch hub CH of the starting clutch WSC is connected to the electric-motor connection shaft 34, the rotation of the clutch hub CH causes the lubricating oil FLD to be supplied to the separate plates SP and friction plates FP. However, in the starting clutch WSC with the internal tooth disc, the rotations of the separate plates SP are stopped whereby the cooling performance is reduced. In the starting clutch WSC with the external tooth disc, the rotations of the friction plates FP are stopped, so that it is unfavorable for suppressing the judder.

Regardless of the construction of the starting clutch WSC, the clutch rotational-speed difference ΔNwsc is increased when the vehicle 10 runs at a running speed within a low speed range, and the clutch input torque Tinwsc is increased when the vehicle 10 runs on an uphill road, so that the amount of heat generated in the starting clutch WSC is increased. If the normal-state rotational speed Neopnml of the oil pump 60 is set to a large rotational speed simply to cope with driving with a large load and a small running speed, there is a concern that the durability of the oil pump 60 could be reduced or cost of the oil pump 60 could be increased.

Therefore, when there is a high possibility of driving the vehicle 10 with a large load and at a small running speed, the pump controller 96 temporarily sets the pump command rotational speed Neopis to a rotational speed larger than the normal-state rotational speed Neopnml. This reduces the amount of heat generation in the starting clutch WSC. In addition, since the pump rotational speed Neop is made large only in a temporary period, it is possible to also suppress reduction of the durability of the oil pump 60.

The electronic control apparatus 90 further includes a state determiner 98 for appropriately suppressing the amount of heat generation in the starting clutch WSC.

The state determiner 98 calculates a road gradient Φ based on, for example, a longitudinal acceleration Gx of the vehicle 10. The road gradient Φ is a gradient of a road on which the vehicle 10 runs. The state determiner 98 determines whether the road gradient Φ is equal to or larger than a predetermined gradient value Φf. When the road gradient Φ is equal to or larger than the predetermined gradient value Φf, the state determiner 98 determines that the running road is an uphill road. When the road gradient Φ is smaller than the predetermined gradient value Φf, the state determiner 98 determines that the running road is a flat road. The predetermined gradient value Φf is a predetermined threshold value for determining whether the vehicle 10 is located on an uphill road that is predicted to be highly likely to be driven with a large load and at a small running speed.

When the state determiner 98 determines that the running road is a flat road, the pump controller 96 sets the pump command rotational speed Neopis to the normal-state rotational speed Neopnml. The normal-state rotational speed Neopnml is also a predetermined flat-road rotational speed that is predetermined as the pump command rotational speed Neopis when the running road is determined to be the flat road. On the other hand, when the state determiner 98 determines that the running road is an uphill road, the pump controller 96 sets the pump command rotational speed Neopis to the uphill-state rotational speed Neopcg. The uphill-state rotational speed Neopcg is a predetermined uphill-road rotational speed that is larger than the normal-state rotational speed Neopnml that is predetermined as the pump command rotational speed Neopis, so as to suppress the amount of heat generation in the starting clutch WSC when the running road is determined to be an uphill road. When the running road is determined to be the uphill road, the pump rotational speed Neop is set larger than when the running road is determined to be the flat road, thereby increasing the amount of oil supplied to the starting clutch WSC. The lubricant flow rate of the oil FLD is increased, thereby improving the cooling performance.

Even when the running road is determined to be an uphill road, if the running speed V is at a certain level, the transmission-input rotational speed Ni is increased and the clutch rotational-speed difference ΔNwsc is reduced. In this case, it is assumed that the starting clutch WSC will be placed into the engaged state earlier. Therefore, the amount of heat generation in the starting clutch WSC is suppressed, so that the pump rotational speed Neop does not need to be increased, and the pump command rotational speed Neopis can remain at the normal-state rotational speed Neopnml.

The state determiner 98 determines whether the clutch rotational-speed difference ΔNwsc(=Nm−Ni) is equal to or larger than the predetermined difference value ΔNwscf. The transmission-input rotational speed Ni is a value determined based on the transmission-output rotational speed No corresponding to the running speed V and a gear position of the automatic transmission 22. For the same gear position, the smaller the running speed V, the larger the clutch rotational-speed difference ΔNwsc. Determining whether the clutch rotational-speed difference ΔNwsc is equal to or larger than the predetermined difference value ΔNwscf is equivalent to determining whether the running speed V is equal to or smaller than the predetermined speed value Vf. The predetermined difference value ΔNwscf and the predetermined speed value Vf are predetermined thresholds for determining whether the vehicle 10 is in a state in which, for example, the starting clutch WSC is expected to be placed into the engaged state early. It is noted that the predetermined speed value Vf is set to a value that varies depending on the position of the automatic transmission 22.

Even when the state determiner 98 determines that the running road is an uphill road, the pump controller 96 sets the pump command rotational speed Neopis to the normal-state rotational speed Neopnml if it determines that the clutch rotational-speed difference ΔNwsc is smaller than the predetermined difference value ΔNwscf.

Even when the running road is determined to be an uphill road, if the clutch input torque Tinwsc is small, the heat generation amount in the starting clutch WSC is small. In this case, the pump rotational speed Neop does not need to be increased, and the pump command rotational speed Neopis can remain at the normal-state rotational speed Neopnml.

The state determiner 98 determines whether the clutch input torque Tinwsc is equal to or smaller than the predetermined torque value Tinwscf. The clutch input torque Tinwsc corresponds to the power source torque Tps required to achieve the drive demand amount DEM, for example. The predetermined torque value Tinwscf is a predetermined threshold value used to determine whether the clutch input torque Tinwsc is small enough to suppress the heat generation amount in the starting clutch WSC, for example.

Even when the state determiner 98 determines that the running road is an uphill road, the pump controller 96 sets the pump command rotational speed Neopis to the normal-state rotational speed Neopnml if it determines that the clutch input torque Tinwsc is equal to or smaller than the predetermined torque value Tinwscf.

Even when the running road is determined to be an uphill road, if the vehicle 10 is stopped due to braking, for example, the accelerator is off and the power source torque Tps is small, so that the heat generation amount in the starting clutch WSC is reduced. In this case, the pump rotational speed Neop does not need to be increased, and the pump command rotational speed Neopis can remain at the normal-state rotational speed Neopnml. When the vehicle 10 is stopped on an uphill road, the vehicle 10 could not be moved even with the accelerator on, but the pump command rotational speed Neopis can remain at the normal-state rotational speed Neopnml only when the vehicle 10 is stopped due to braking.

The state determiner 98 determines whether the vehicle state is “brake-ON and stopped”. The state determiner 98 determines whether the vehicle 10 is being braked based on the brake-ON signal Bon. The state determiner 98 determines whether the vehicle 10 is being stopped based on whether the running speed V is a value that can be determined to be zero.

Even when the state determiner 98 determines that the running road is an uphill road, the pump controller 96 sets the pump command rotational speed Neopis to the normal-state rotational speed Neopnml if the vehicle state is determined to be “brake-ON and stopped”.

The clutch input torque Tinwsc being equal to or smaller than the predetermined torque value Tinwscf and the vehicle state being “brake-ON and stopped” are common in that the heat generation amount in the starting clutch WSC is made small. The state determiner 98 may determine whether the clutch input torque Tinwsc is equal to or smaller than the predetermined torque value Tinwscf or may determine whether the vehicle state is “brake-ON and stopped”.

When the state determiner 98 determines that the running road is an uphill road, the pump controller 96 sets the pump command rotational speed Neopis to the uphill-state rotational speed Neopcg, if the state determiner 98 determines that the running speed V is equal to or smaller than the predetermined speed value Vf, the clutch input torque Tinwsc is larger than the predetermined torque value Tinwscf and the vehicle state is not “brake-ON and stopped”.

Even when the state determiner 98 determines that the running road is an uphill road, the pump controller 96 sets the pump command rotational speed Neopis to the normal-state rotational speed Neopnml, if the state determiner 98 determines that the running speed V is larger than the predetermined speed value Vf, the clutch input torque Tinwsc is equal to or smaller than the predetermined torque value Tinwscf or the vehicle state is “brake-ON and stopped.”

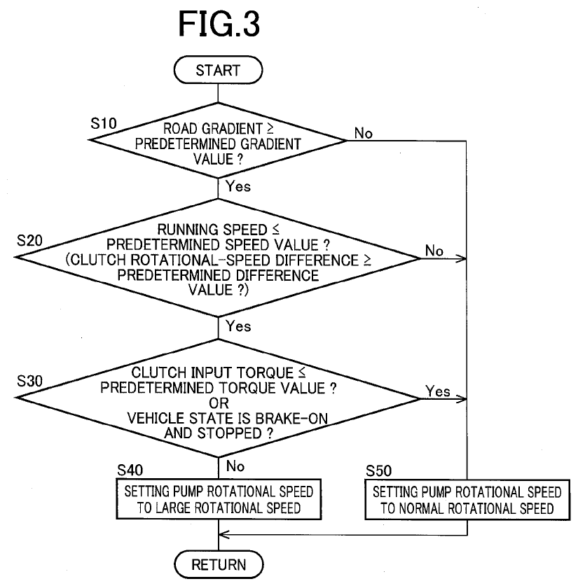

FIG. 3 is a flowchart showing a main control operation of the electronic control apparatus 90, namely, a control routine executed by the electronic control apparatus 90 for suppressing the amount of heat generation in the starting clutch WSC when the vehicle 10 starts running or runs on an uphill road. This control routine is executed, for example, in a repeated manner.

As shown in FIG. 3, the control routine is initiated with step S10 corresponding to function of the state determiner 98, which is implemented to determine whether the road gradient Φ is equal to or larger than the predetermined gradient value Φf. When an affirmative determination is made at step S10, step S20 corresponding to function of the state determiner 98 is implemented to determine whether the running speed V is equal to or smaller than the predetermined speed value Vf, namely, whether the clutch rotational-speed difference ΔNwsc is equal to or larger than the predetermined difference value ΔNwscf. When an affirmative determination is made at step S20, step S30 corresponding to function of the state determiner 98 is implemented to determine whether the clutch input torque Tinwsc is equal to or smaller than the predetermined torque value Tinwscf, or whether the vehicle state is “brake-ON and stopped”. When a negative determination is made at step S30, step S40 corresponding to function of the pump controller 96 to set the pump command rotational Neopis to the uphill-state rotational speed Neopcg. In other words, an instruction to set the pump rotational speed Neop to a large rotational speed is made. When a negative determination is made at step S10 or at step S20, or when an affirmative determination is made at step S30, the control flow goes to step S50 corresponding to function of the pump controller 96, which is implemented to set the pump command rotational speed Neopis to the normal-state rotational speed Neopnml. In other words, an instruction to set the pump rotational speed Neop to the normal rotational speed is made.

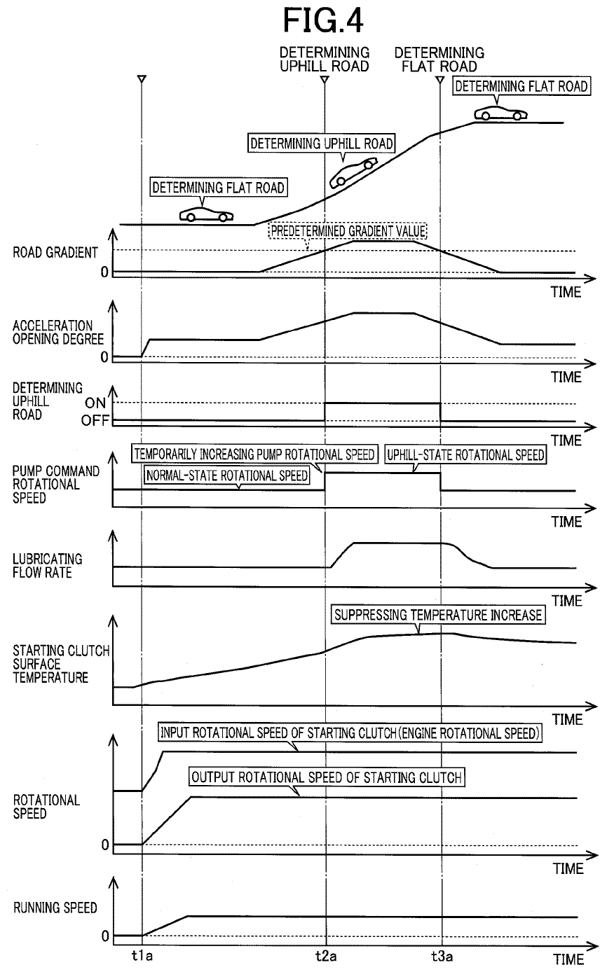

FIG. 4 is a time chart when the control routine shown in the flowchart of FIG. 3 is executed in a case in which the vehicle 10 enters an uphill road during running of the vehicle 10. In FIG. 4, a time point t1a indicates a point of time at which the accelerator pedal is started to be depressed during running of the vehicle 10 on a flat road, and the vehicle 10 is caused to start running. During running of the vehicle 10 on the flat road, when the running road is determined to be an uphill road because the road gradient Φ is determined to be equal to or larger than the predetermined gradient value Φf, the pump command rotational speed Neopis is switched from the normal-state rotational speed Neopnml to the uphill-state rotational speed Neopcg (see time point t2a). During running of the vehicle 10 on the uphill road, when the running road is determined to be a flat road because the road gradient Φ is determined to be smaller than the predetermined gradient value Φf, the pump command rotational speed Neopis is switched back to the normal-state rotational speed Neopnml (see time t3a). During running of the vehicle 10 on the uphill road, the pump rotational speed Neop is temporarily increased, thereby increasing the lubricating oil flow rate of the oil FLD supplied to the starting clutch WSC and suppressing the increase of the surface temperature in the starting clutch WSC. In this example shown in FIG. 4, the running of the vehicle 10 is continued with a small running speed being kept, so that the starting clutch WSC is controlled to the slip state.

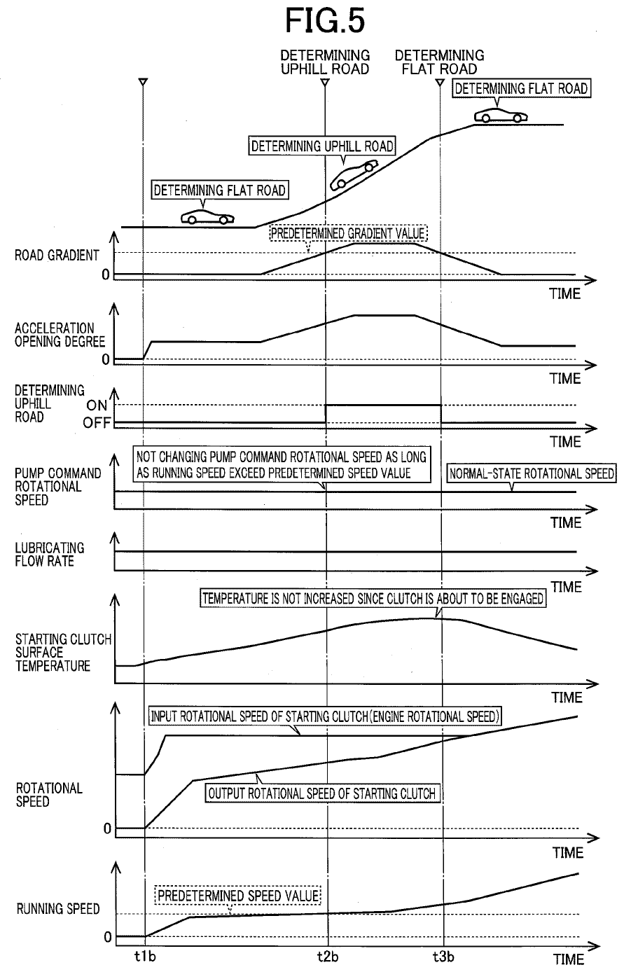

FIG. 5 is a time chart when the control routine shown in the flowchart of FIG. 3 is executed in a case in which the running speed V is increased after the vehicle 10 enters an uphill road during running of the vehicle 10. In FIG. 5, a time point t1b indicates a point of time at which accelerator pedal is started to be depressed on a flat road, causing the vehicle 10 to start moving. During running of the vehicle 10 on the flat road, the running road is determined to be an uphill road because the road gradient Φ is determined to be equal to or larger than the predetermined gradient value Φf (see time point t2b). During running of the vehicle 10 on the uphill road, the running road is determined to be a flat road because the road gradient Φ is determined to be smaller than the predetermined gradient value Φf (see time point t3b). Even when the running road is determined to be an uphill road, if the running speed V is determined to exceed the predetermined speed value Vf, the clutch rotational-speed difference ΔNwsc is small and the starting clutch WSC is assumed to be about to be switched to the engaged state, so that there is no need to increase the pump rotational speed Neop. Therefore, the pump command rotational speed Neopis is not changed from the normal-state rotational speed Neopnml (see time period t2b-t3b). For this determination, instead of using the running speed V, the clutch rotational-speed difference ΔNwsc may be used. Even during running of the vehicle 10 on an uphill road, the lubricating flow rate of the oil FLD supplied to the starting clutch WSC is not increased. However, since the starting clutch WSC is about to be switched to the engaged state, the amount of heat generation in the starting clutch WSC is suppressed, thereby suppressing an increase of surface temperature. In this example shown in FIG. 5, the starting clutch WSC is switched from the slip state to the engaged state as the running speed V is increased.

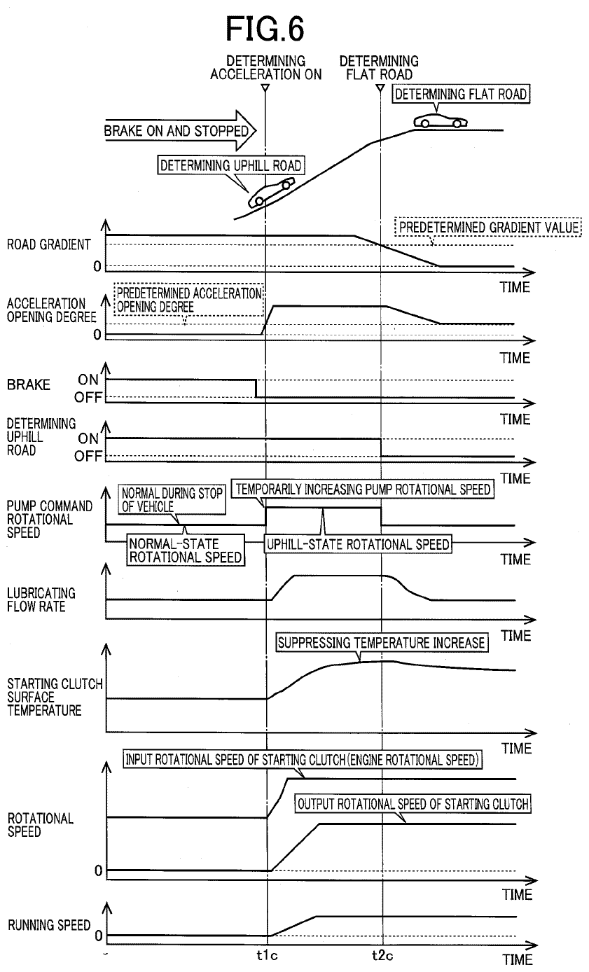

FIG. 6 is a time chart when the control routine shown in the flowchart of FIG. 3 is executed in a case in which the vehicle 10 starts running on an uphill road. In FIG. 6, the period before a time point t1c shows a state in which the running road is determined to be an uphill road because the road gradient Φ is determined to be equal to or larger than the predetermined gradient value Φf. Even when the running road is determined to be an uphill road, if the vehicle 10 is being stopped with the brake being stepped, the heat generation amount in the starting clutch WSC is small, so that there is no need to increase the pump rotational speed Neop. Therefore, the pump command rotational speed Neopis is not changed from the normal-state rotational speed Neopnml (see before time point t1c). When the vehicle 10 is “brake-ON and stopped” on an uphill road, the accelerator pedal depression operation is initiated whereby the vehicle 10 is caused to start running (see after time point t1c). When the vehicle 10 is “brake-ON and stopped” on an uphill road, if it is determined that the brake is OFF and then that the acceleration opening degree θacc has exceeded a predetermined acceleration opening degree θaccf, the pump command rotational speed Neopis is switched from the normal-state rotational speed Neopnml to the uphill-state rotational speed Neopcg (see time point t1c). Determining whether the acceleration opening degree θacc is equal to or smaller than the predetermined acceleration opening degree θaccf is equivalent to determining whether the clutch input torque Tinwsc is equal to or smaller than the predetermined torque value Tinwscf. The predetermined acceleration opening degree θaccf is a predetermined threshold value for determining whether the clutch input torque Tinwsc is large enough to suppress the heat generation amount in the starting clutch WSC, for example. During running of the vehicle 10 on an uphill road, when the running road is determined to be a flat road because the road gradient Φ is determined to be smaller than the predetermined gradient value Φf, the pump command rotational speed Neopis is switched back to the normal-state rotational speed Neopnml (see time point t2c). When the vehicle is “brake-ON and stopped” on an uphill road, the pump rotational speed Neop is not increased. When the “brake-ON and stopped” state is released on an uphill road and it is determined that the vehicle 10 is accelerated at a predetermined level or more, the pump rotational speed Neop is temporarily increased. This increases the lubricating flow rate of the oil FLD supplied to the starting clutch WSC, and suppresses the surface temperature of the starting clutch WSC from being increased. In an example shown in FIG. 6, the running of the vehicle 10 is continued with a small running speed being kept, so that the starting clutch WSC is controlled to the slip state.

As described above, according to this embodiment, when the running road is determined to be a flat road, the pump command rotational speed Neopis is set to the normal-state rotational speed Neopnml. On the other hand, when the running road is determined to be an uphill road, the pump command rotational speed Neopis is set to the uphill-state rotational speed Neopcg. As a result, when the running road is an uphill road, the lubricating flow rate of oil FLD supplied to the starting clutch WSC is increased as compared to when the running road is a flat road, thereby making it easier to cool the starting clutch WSC. Because a large pump rotational speed Neop is only set on an uphill road, activation of the protection control for the oil pump 60 is suppressed, thereby making it smaller likely that the oil pump 60 will be stopped. Therefore, the amount of heat generated in the starting clutch WSC can be suppressed when the vehicle 10 is caused to start running or is caused to run on an uphill road.

Further, according to this embodiment, even when the running road is determined to be an uphill road, if it is determined that the clutch rotational-speed difference ΔNwsc is smaller than the predetermined difference value ΔNwscf, the pump command rotational speed Neopis is set to the normal-state rotational speed Neopnml. As a result, when it is expected that the starting clutch WSC will be soon placed into the engaged state, the pump rotational speed Neop is not increased, thereby improving the energy efficiency of the vehicle 10. Moreover, since the pump rotational speed Neop is not increased, a reduction of the durability of the oil pump 60 is suppressed.

Further, according to this embodiment, even when the running road is determined to be an uphill road, if it is determined that the clutch input torque Tinwsc is equal to or smaller than the predetermined torque value Tinwscf, the pump command rotational speed Neopis is set to the normal-state rotational speed Neopnml. As a result, when the heat generation amount in the starting clutch WSC is small, the pump rotational speed Neop is not increased, thereby improving the energy efficiency of the vehicle 10. Moreover, since the pump rotational speed Neop is not increased, a reduction of the durability of the oil pump 60 is suppressed.

Further, according to this embodiment, even when the running road is determined to be an uphill road, if the vehicle state is determined to be “brake-ON and stopped,” the pump command rotational speed Neopis is set to the normal-state rotational speed Neopnml. As a result, when the heat generation amount in the starting clutch WSC is small, the pump rotational speed Neop is not increased, thereby improving the energy efficiency of the vehicle 10. Moreover, since the pump rotational speed Neop is not increased, a reduction of the durability of the oil pump 60 is suppressed.

Further, according to this embodiment, when the running road is determined to be an uphill road, if it is determined that the running speed V is equal to or smaller than the predetermined speed value Vf, that the clutch input torque Tinwsc is not larger than the predetermined torque value Tinwscf, and that the vehicle state is not “brake-ON and stopped,” the pump command rotational speed Neopis is set to the uphill-state rotational speed Neopcg. As a result, when it is not expected that the starting clutch WSC will be soon placed into the engaged state on an uphill road, or when the amount of heat generation in the starting clutch WSC is large, the starting clutch WSC is cooled more easily. Since a large pump rotational speed Neop is only set in a limited manner on an uphill road, activation of the protective control for the oil pump 60 is suppressed, thereby making it difficult for the oil pump 60 to be stopped.

Further, according to this embodiment, even when the running road is determined to be an uphill road, if it is determined that the running speed V is larger than the predetermined speed value Vf, that the clutch input torque Tinwsc is equal to or smaller than the predetermined torque value Tinwscf, or that the vehicle state is “brake-ON and stopped,” the pump command rotational speed Neopis is set to the normal-state rotational speed Neopnml. As a result, when the starting clutch WSC is expected to be soon placed into the engaged state on an uphill road, or when the heat generation amount in the starting clutch WSC is small, the energy efficiency of the vehicle 10 is improved, or a reduction of the durability of the oil pump 60 is suppressed.

Although the embodiment of the present invention has been described in detail above with reference to the drawings, the present invention can also be applied to other embodiments.

For example, in the above-described embodiment, the automatic transmission 22 may be, for example, a known DCT (Dual Clutch Transmission). Further, the starting clutch WSC may be a friction clutch that constitutes a part of the automatic transmission 22. Further, the power source PS may be, for example, the engine 12 alone, or the electric motor MG alone. Further, where the starting clutch WSC is a friction clutch that transmits only the power of the electric motor MG, the automatic transmission 22 may not be provided. In short, the present invention can be applied to any vehicle that includes a power source PS, a starting clutch WSC and an oil pump 60.

In the above-described embodiment, the acceleration opening degree θacc and the clutch input torque Tinwsc are related with each other. However, the present invention is limited to this detail. For example, where the drive demand amount DEM is required by a known cruise control function, the clutch input torque Tinwsc may be increased or reduced during acceleration OFF.

In the above-described embodiment, at least one of steps S20 and S30 shown in FIG. 3 may not be provided. For example, where step S30 is not provided, when the running road is determined to be an uphill road and it is determined that the clutch rotational-speed difference ΔNwsc is equal to or larger than the predetermined difference value ΔNwscf, the pump command rotational speed Neopis is set to the uphill-state rotational speed Neopcg.

It should be noted that the above is merely one embodiment, and the present invention can be practiced in various forms with various modifications and improvements based on the knowledge of those skilled in the art.

### NOMENCLATURE OF ELEMENTS

10: vehicle
14: drive wheel
60: oil pump (electric fluid pump)
90: electronic control apparatus (control apparatus)
94: hydraulic controller (clutch controller)
96: pump controller
98: state determiner
FLD: oil (fluid)
PS: power source
WSC: starting clutch (friction clutch)

What is claimed is:

1. A control apparatus for a vehicle which is to run on a running road and which includes (i) a drive wheel, (ii) a power source, (iii) a wet multi-plate friction clutch provided in a power transmission path between the power source and the drive wheel and (iv) an electric fluid pump that is to be driven at a pump rotational speed so as to supply a fluid for lubricating the friction clutch,
the control apparatus comprising:
a clutch controller configured to place the friction clutch into a slip state, when the vehicle is caused to start running or is caused to run at a running speed within a predetermined small speed range;
a state determiner configured to determine that the running road is an uphill road when a road gradient is not smaller than a predetermined gradient value, and to determine that the running road is a flat road when the road gradient is smaller than the predetermined gradient value; and
a pump controller configured, when it is determined that the running road is the flat road, to set the pump rotational speed to a predetermined flat-road rotational speed, and configured, when it is determined that the running road is the uphill road, to set the pump rotational speed to a predetermined uphill-road rotational speed that is larger than the flat-road rotational speed.

2. The control apparatus according to claim 1,
wherein the state determiner is configured to determine whether a difference between input and output rotational speeds of the friction clutch is equal to or larger than a predetermined difference value, and
wherein the pump controller is configured to set the pump rotational speed to the flat-road rotational speed in a case in which it is determined that the difference between the input and output rotational speeds of the friction clutch is smaller than the predetermined difference value even when it is determined that the running road is the uphill road.

3. The control apparatus according to claim 1,
wherein the state determiner is configured to determine whether an input torque to the friction clutch is equal to or smaller than a predetermined torque value, and
wherein the pump controller is configured to set the pump rotational speed to the flat-road rotational speed in a case in which it is determined that the input torque to the friction clutch is equal to or smaller than the predetermined torque value even when it is determined that the running road is the uphill road.

4. The control apparatus according to claim 1,
wherein the state determiner is configured to determine whether the vehicle is being stopped with a brake being applied to the vehicle, and
wherein the pump controller is configured to set the pump rotational speed to the flat-road rotational speed in a case in which it is determined that the vehicle is being stopped with the brake being applied to the vehicle even when it is determined that the running road is the uphill road.

5. The control apparatus according to claim 1,
wherein the state determiner is configured to determine whether the running speed of the vehicle is equal to or smaller than a predetermined speed value,
wherein the state determiner is configured to determine whether an input torque to the friction clutch is equal to or smaller than a predetermined torque value, or to determine whether the vehicle is being stopped with a brake being applied to the vehicle,
wherein the pump controller is configured to set the pump rotational speed to the uphill-road rotational speed, in a case in which it is determined that the running speed of the vehicle is not larger than the predetermined speed value, that the input torque to the friction clutch is larger than the predetermined torque value, and that the vehicle is not being stopped with the brake being applied to the vehicle, when it is determined that the running road is the uphill road, and
wherein the pump controller is configured to set the pump rotational speed to the flat-road rotational speed, in a case in which it is determined that the running speed of the vehicle is larger than the predetermined speed value, that the input torque to the friction clutch is equal to or smaller than the predetermined torque value, or that the vehicle is being stopped with the brake being applied to the vehicle, even when it is determined that the running road is the uphill road.
